(19) United States
(12) Patent Application Publication
(10) Pub. No.: US 2003/0122861 A1
(43) Pub. Date: Jul. 3, 2003

(54) Method, interface and apparatus for video browsing

(75) Inventors: Sung Bae Jun, Seoul (KR); Kyoung Ro Yoon, Seoul (KR)

Correspondence Address: LEE & HONG, 801 SOUTH FIQUEROA STREET, 14TH FLOOR, LOS ANGELES, CA, 90017, US

(73) Assignee: LG Electronics Inc.

(21) Appl. No.: 10/263,049

(22) Filed: Oct. 1, 2002

(30) Foreign Application Priority Data
Dec. 29, 2001 (KR) 88261/2001

(51) Int. Cl. G09G 5/00

(52) U.S. Cl. 345/720; 345/721

(57) ABSTRACT

The present invention relates to a method, interface and apparatus for video browsing, through which the information of video content and structure are simultaneously delivered to users. If there is more space available for display, a scene key frame list, a scene structure key frame list, a shot key frame list or a moving picture viewer can be further displayed. Accordingly, users can understand entire content of the video even within a small space, and can easily shift to any desired position through a simple operation of keys.

### BACKGROUND OF THE INVENTION

1. Field of the Invention

The present invention relates to a method, interface and apparatus for video browsing, which is capable of representing the information on video content and its structure at the same time.

2. Description of the Related Art

The most basic technologies for non-linear video content browsing and searching are shot segmentation and shot clustering. These two technologies are the core of structural analysis of multimedia contents.

FIG. 1 illustrates structural information of a video stream. Referring to FIG. 1, a time-continuous video stream has structural information. Generally, a video stream has a hierarchical structure, regardless of genre. In other words, the video stream is divided into several logical units, or scenes, and each scene includes a number of sub-scenes or shots. Since the sub-scene is also a scene, it has the same attributes of the scene. A shot in the video stream means a sequence of video frames obtained from a camera without any interruption. Therefore, the shot is the most fundamental unit for analyzing or constructing a video. In addition, a scene, which is a semantic structural element of a video, is a semantic segmentation element for developing a story or for constructing a video. Normally, a scene includes a plurality of shots.

A known video indexing technology analyzes a video structure by detecting shots and scenes, and based on the analysis, it extracts a key frame that can represent a unit segment, shot or scene. Thusly extracted key frame represents each shot or scene, and is used as data for summarizing the video or as a means for moving to a desired position.

Recently, many researches that are actively in progress are focused on extraction of a key frame and user interface using the same to provide users with a means for summarizing entire contents and structure of the video and for moving or downloading them to a desired position more easily.

Typically, a key frame is extracted on the basis of editing unit of the video content, shot, or on the basis of logical story unit of the video content, scene. The interface with the most basic storyboard format generally extracts a key frame based on the shots, and displays it to a one-dimensional interface. Using such interface, users can move a present watching position to another desired position, or download only part of video content they want from a remote position where the video content is stored.

Although the key frame interface can be operated in an independent system (for example, a user terminal unit), it can also be used over the network (for example, between a client and a server). That is, even in a situation like VOD (Video On Demand), the user can get a rough summary of video content through the key frame interface, and may select a part he or she wants and download the part within a very short time, screening out only the information about the part he or she wants.

As an example, if a user wants to watch a sports news section only out of a news video, he or she can select the sport news section using the key frame interface, and download the corresponding part only. This indeed makes possible much more effective video browsing compared to the conventional time-basis search.

However, the one-dimensional storyboard interface in the related art requires a large number of key frames to be displayed at once for representing the entire contents, so it is difficult to convey much information to a limited display space. Moreover, contents like films or dramas provide too much unnecessary information to the user using similar scenes in the contents, and this eventually gives the user a hard time to find the scene he or she wants.

As an attempt to solve the problems, recently introduced tool is a TOC (Table Of Contents) interface, which analyzes characteristics of many shots, and based on the analysis, detects logical scenes, and represents each scene and shot by key frames that are provided to an interface. TOC interface extracts each key frame represents a scene or a shot out of the video content, and key frames are displayed using tree structure, through which the user can search a certain scene the user wants among the key frames representing scenes, and if the user wants more details on a particular scene, the user can go further to a shot level and eventually to the part the user has been looking for. Such TOC interface is able to exhibit contents of the video and its structure simultaneously, and for that reason, it has been regarded very important especially for non-linear video browsing in which the user can select his or her favorite part only.

Unfortunately however, TOC interface is useful or convenient only in an environment having large screen and an additional interface like a keyboard or mouse, and it turns out to be rather inconvenient for the user in an environment without additional interface such as TV or mobile terminals. Also, the user must issue many operations to find out if a key frame in the TOC interface actually includes a desired scene in its lower hierarchy.

### SUMMARY OF THE INVENTION

An object of the invention is to solve at least the above problems and/or disadvantages and to provide at least the advantages described hereinafter.

Accordingly, one object of the present invention is to provide a method and apparatus for video browsing, which is capable of representing the information on video content and its structure at the same time.

It is another object of the present invention to provide a method and apparatus for video browsing, which is capable of representing the information on video content and its structure at the same time in an independent system or network environment.

It is still another object of the present invention to provide a method and apparatus for video browsing, which is capable of representing the information on video content and its structure at the same time in an environment without a keyboard or mouse.

It is yet another object of the present invention to provide a method and apparatus for video browsing, which enables a user to move to any position the user wants.

These and other objects and advantages of the invention are achieved by providing a method and interface for video browsing, which simultaneously displays a scene key frame list composed of key frames that represent each scene, and a scene structure key frame list composed of important key frames of each scene on the scene key frame list.

According to the method and interface for video browsing, when a certain key frame is selected from the scene key frame list, a moving picture viewer corresponding to the selected key frame can be further displayed for reproducing a corresponding moving picture section. Here, the moving picture viewer can reproduce a media file from a start position of the section the selected key frame represents.

Also, according to the method and interface for video browsing of the present invention, a shot key frame list can be further displayed, wherein the shot key frame list is composed of key frames representing a shot included in the scene selected from the scene key frame list.

The important key frames are frames that represent internal structures of each scene.

The method and interface for video browsing described above provides a way to display the moving picture viewer that reproduces a moving picture section corresponding to each key frame on the scene key frame list or on the scene structure key frame list, and to display the shot key frame list that is composed of key frames representing a shot included in the scene selected from the scene key frame list.

According to another aspect of the invention, an apparatus for video browsing includes: a video browsing interface for displaying a scene key frame list composed of key frames representing each scene and a scene structure key frame list composed of important key frames of each scene on the scene key frame list; a control means for controlling reproduction of a media file according to index information, and for controlling, at a user's request, non-linear video browsing based on the scene key frame list and the scene structure key frame list; an input means for receiving the user's request; a media file storing means for providing a media file for video browsing; and an index storing means for storing index information that includes structural information about scenes or shots, and relevant key frame structure information connected thereto and time information thereof.

Preferably, a key frame is selected from the scene key frame list, the video browsing interface can further include a moving picture viewer for reproducing a moving picture section corresponding to the selected key frame.

Moreover, the video browsing interface can further include a shot key frame list that is composed of key frames representing shots included in the scene selected from the scene key frame list.

When the video browsing is conducted on a client-server environment, the apparatus for video browsing of the present invention enables the media file storing means and the index storing means implemented on the server to provide the client apparatus with a corresponding media file through communication network based on index information.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates structural information of a video stream;

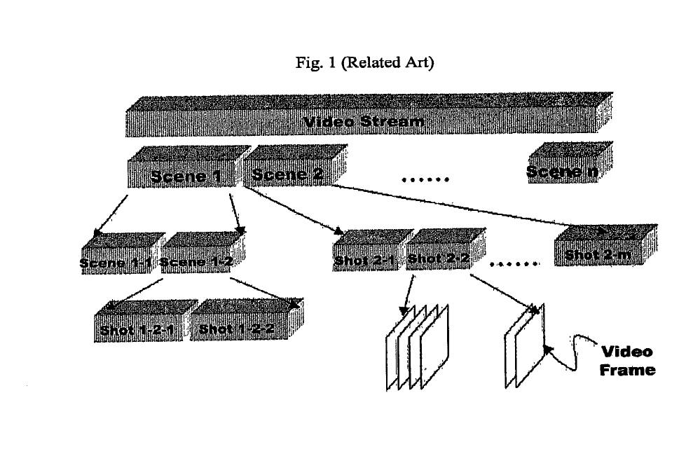

FIG. 2 illustrates a video browsing interface employed to explain a video browsing method in accordance with a first preferred embodiment of the present invention;

FIG. 3 illustrates a video browsing interface employed to explain a video browsing method in accordance with a second preferred embodiment of the present invention;

FIG. 4 illustrates a video browsing interface employed to explain a video browsing method in accordance with a third preferred embodiment of the present invention;

FIG. 5 illustrates a video browsing interface employed to explain a video browsing method in accordance with a fourth preferred embodiment of the present invention; and

FIG. 6 is a schematic diagram of a video browsing apparatus in accordance with a preferred embodiment of the present invention.

### DETAILED DESCRIPTION OF THE PREFERRED EMBODIMENT

The following detailed description will present a preferred embodiment of the invention in reference to the accompanying drawings.

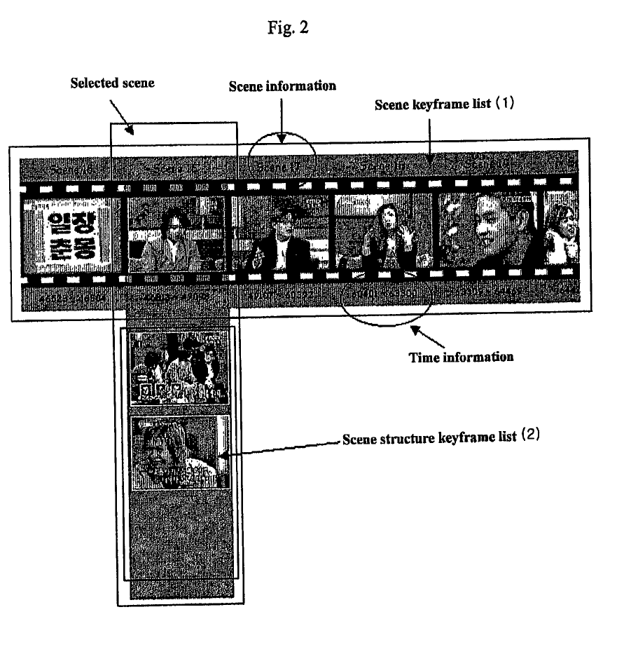

FIG. 2 illustrates a video browsing interface according to the first preferred embodiment of the present invention, in which the video browsing interface is capable of displaying a scene key frame list and a scene structure key frame list for a selected scene at the same time.

More specifically, the video browsing interface according to the first embodiment of the present invention can simultaneously display a scene key frame list 1 composed of key frames representing each scene, and a scene structure key frame list 2 composed of important key frames of each scene on the scene key frame list. Here, the important key frames indicate the frames representing internal structures of each scene.

Although the video browsing interface depicted in FIG. 2 illustrates a case where the scene key frame list 1 is provided horizontally, and the scene structure key frame list 2 is provided vertically, and vice versa. The scene key frame list 1 is a set of key frames representing each scene, and one representative key frame is selected to represent the corresponding scene. So, it is desirable to select a scene representing the corresponding scene most well as a representative key frame. It is also preferable to put the scene key frame list 1 in time sequence. Moreover, each key frame on the scene key frame list is displayed according to index information, based on the start time of a media file.

The user can easily move to a position of a media file he or she wants by determining which part of key frames represents a desired scene, and selecting a corresponding key frame.

The scene structure key frame list 2 includes important key frames besides those representative key frames. In other words, the scene structure key frame list 2 is composed of several important key frames representing a corresponding scene very well out of one scene having a sub-structure.

Actually, there are several ways to select the scene structure key frame list 2. In case of movies or dramas, similar shots are repeatedly shown in a scene. For example, there is a method to represent shots that are repeatedly shown in a scene as a key frame based upon such a repetition of similar shots, and to select a shot having the highest frequency or longest running time for each repetition unit as a key frame. On the other hand, in case of news or sports, in which the repetition of similar shots in a scene is relatively low, a key frame can be selected based upon a stillness of a shot or a running time of the shot.

Therefore, the user can easily shift the scenes because it is possible to move left to right using just two keys, and the user can quickly figure out rough contents of the scene because the scene structure key frame list is provided for a selected scene. Moreover, by selecting a desired key frame from the scene key frame list 1, the user can shift to a segment that each key frame represents in a scene. In this manner, it is possible to conduct a non-linear video browsing with more detailed levels.

According to the first embodiment of the invention shown in FIG. 2, there is provided a means for implicitly providing the content and the structure of a scene within a limited space. Thus, the user can easily change a reproduction position of the scene to any position he or she wants or understand the entire content at once.

Particularly, the video browsing interface illustrated in FIG. 2 displays just a scene key frame list and a scene structure key frame list, and it does not present a viewer on which a media file is reproduced. However, in some cases, it can be convenient for users to present a scene key frame list, a scene structure key frame list, and a viewer for reproducing a media file all together.

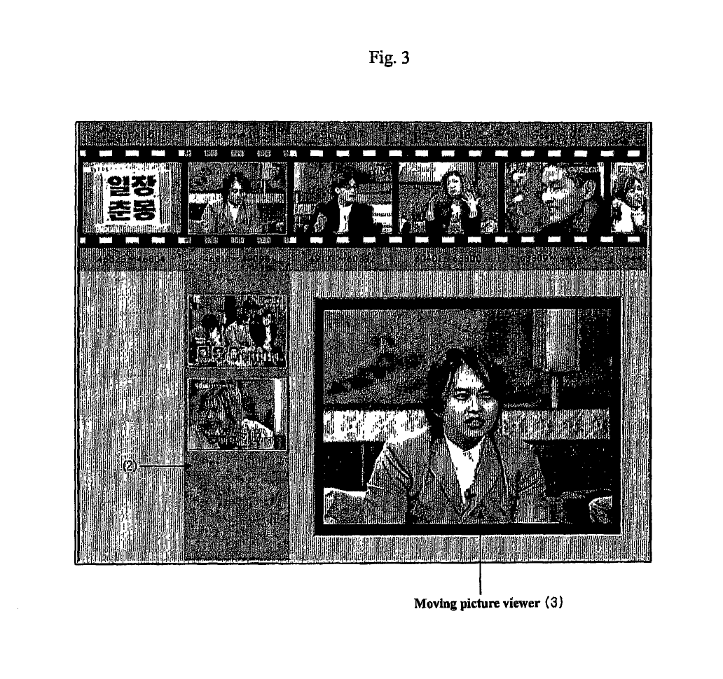

FIG. 3 illustrates a video browsing interface according to the second embodiment of the present invention, which is capable of simultaneously displaying a scene key frame list, a scene structure key frame list for a selected scene, and a viewer for reproducing a media file.

According to the second embodiment of the present invention, the video browsing interface includes a scene key frame list 1, a scene structure key frame list 2, and a moving picture viewer 3. Once a corresponding scene is selected, the interface reproduces a media file from the first position of the subject scene through the moving picture viewer.

The second embodiment is basically identical to the first embodiment of FIG. 2. The only difference is that the second embodiment can display the scene key frame list 1, the scene structure key frame list 2, and the moving picture viewer 3 at the same time. Therefore, when the user selects a key frame representing a certain scene out of the scene key frame list, a media file is reproduced through the moving picture viewer 3 from the first position of the corresponding scene.

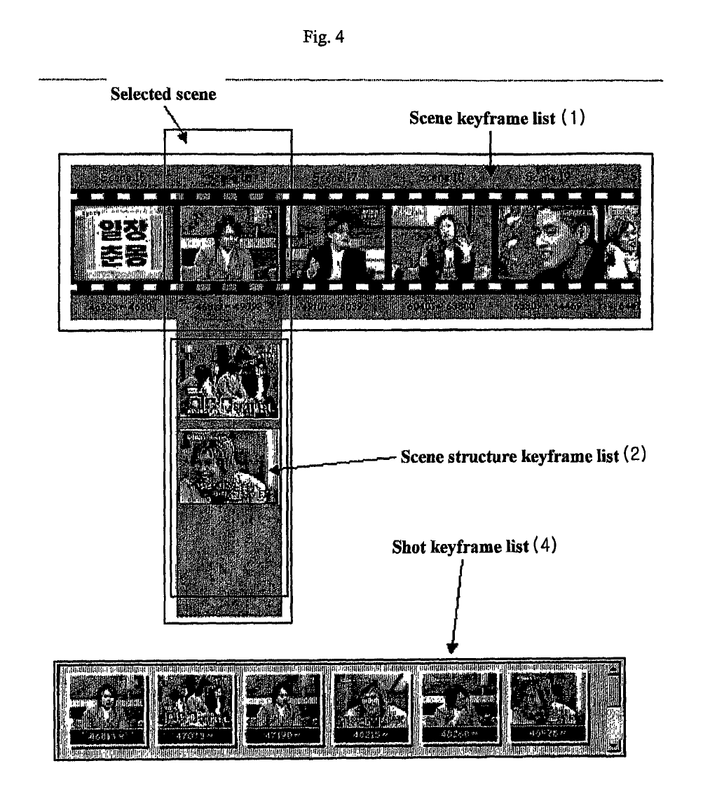

FIG. 4 is a diagram of a video browsing interface according to the third embodiment of the present invention, which can simultaneously display a scene key frame list, a scene structure key frame list, and a shot key frame list.

The video browsing interface of the third embodiment of the present invention makes possible to conduct more detailed non-linear video browsing by additionally displaying a shot key frame list 4, if there is a space available, so the user can understand the entire content more clearly.

Preferably, the shot key frame list 4 is composed of representative key frames of shots included in the scenes selected from the scene key frame list 1.

In general, there are several shots in one scene. In the third embodiment of the present invention, a number of shots are sequentially arranged in time, and it displays the shot key frame list 4 composed of key frames for representing the shots.

In principle, the third embodiment is identical to the first embodiment of the present invention, except that the video browsing interface of the third embodiment further includes the shot key frame list 4. Accordingly, the user can get a feature of the content through the key frames included in the shot key frame list 4. Furthermore, the user can make a non-linear approach based on a scene unit as well as a non-linear approach based on a shot unit.

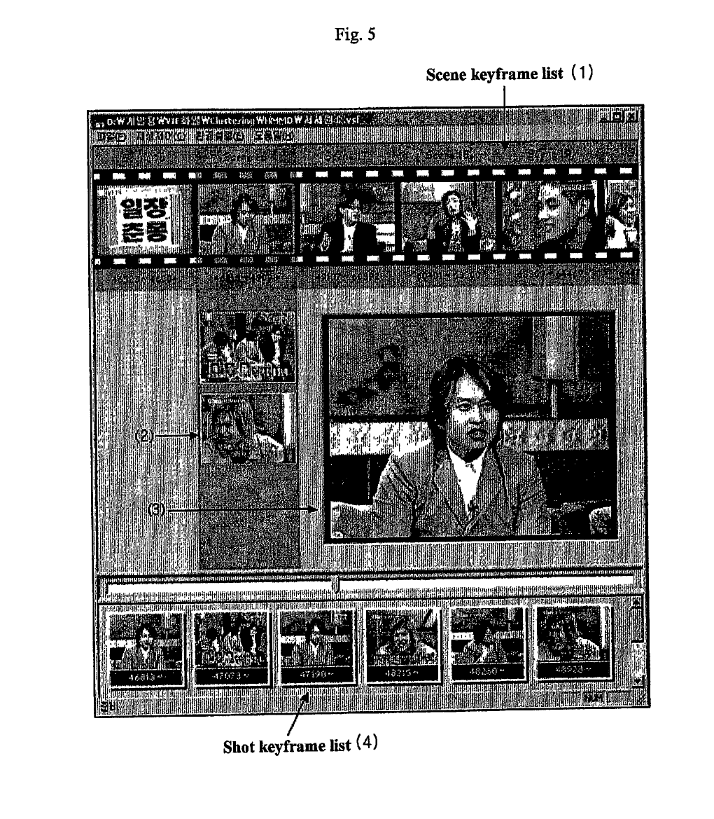

FIG. 5 depicts a video browsing interface according to the fourth embodiment of the present invention, which is capable of simultaneously displaying a scene key frame list, a scene structure key frame list, a shot key frame list, and a moving picture viewer all together.

The video browsing interface according to the fourth embodiment of the present invention is especially useful when there is a lot of space available for display. In fact, it's a video browsing interface holding all advantages of the first, the second, and the third embodiments described before.

When a key frame is selected out of the scene key frame list 1 or the shot key frame list 4, the moving picture viewer 3 reproduces a media file from a start point of a moving picture section corresponding to the selected key frame. More specifically, if a key frame included in the scene key frame list 1 is selected, the media file is reproduced from the first position of the scene. In contrast, if a key frame included in the shot key frame list 4 is selected, the media file is reproduced from the start position of the shot.

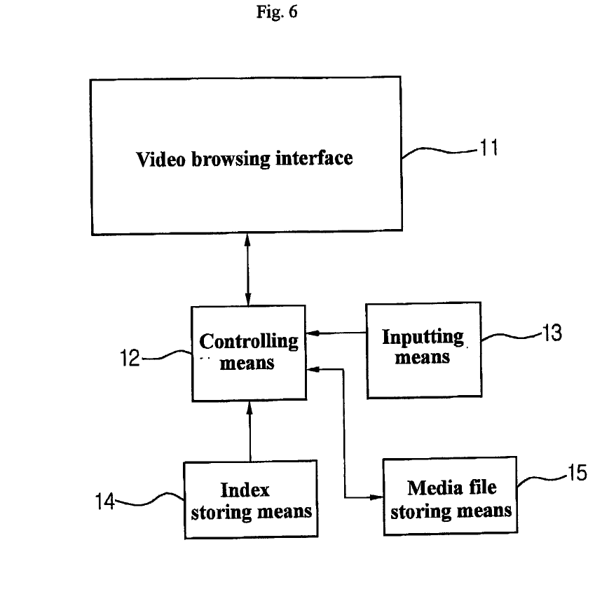

FIG. 6 is a schematic diagram of a video browsing apparatus equipped with a video browsing interface for representing content of the scene and structural information on the scene at the same time.

Referring to FIG. 6, the video browsing apparatus includes a video browsing interface 11, a control means 12, an input means 13, a media file storing means 15, and an index storing means 14. Here, if the video browsing apparatus is an independent apparatus, it includes the media file storing means 15 and the index storing means 14. However, if not, the media file storing means 15 and the index storing means 14 should be included in another apparatus. For instance, in case of a client-server environment, wherein users transmit and receive some information over a communication network, the video browsing interface 11, the control means 12, and the input means 14 are included in the client apparatus, and the media file storing means 15 and the index storing means 14 are included in the server. Thus, the user makes a request to the server using the client apparatus through a communication network, and upon request of users, the server provides users with a corresponding media file through the client apparatus. In such manner, the user can understand what the content is about by the video browsing interface 11 for representing the content and structure of the scene.

The video browsing interface 11 can simultaneously display the scene key frame list composed of key frames representing each scene, and the scene structure key frame list composed of important key frames of each scene on the scene key frame list.

The control means 12 controls the reproduction of a media file according to index information, and upon request of the user, it controls a non-linear video browsing based on the scene key frame list and the scene structure key frame list.

The control means 12 also prepares relevant index information by loading the media file.

When the user requests video browsing, the control means 12 sends the related scene key frame list, scene structure key frame list, shot key frame list, or moving picture viewer for the media file to the video browsing interface 11, and controls the display of them. At this time, the controlling means 12 utilizes structures of scenes or shots specified in the index structural information in the index storing means 14, and utilizes other relevant key frame information.

The input means 13 is provided for receiving the user's request. Generally, a keyboard, a remote controller, or a mouth can be used as the input means 13.

The media file storing means 15 stores a variety of media in files to provide an appropriate media file for video browsing to the user.

The index storing means 14 stores structural information about scenes or shots, and index information including relevant key frame information and time information.

Therefore, using the video browsing apparatus, the user can understand the video content and a story development by watching the key frames that are displayed through the video browsing interface 11, and can easily shift to a desired scene or shot using the input means 13. In addition, the video browsing apparatus analyzes the user's request, and adjusts a present position of a related media file using index information, and displays the media file through the video browsing interface.

In conclusion, according to the method, interface and apparatus for video browsing of the present invention, users can figure out video content more clearly by using key frames that present contents and structures of scenes simultaneously in a two-dimensional space.

Moreover, users can easily move to a desired position by selecting key frames they are interested in through a simple operation of keys.

Further, because such a simple operation of a few keys makes it possible to implement the navigation between key frames, the present invention can be adapted to another fields such as TV remote controllers and small terminal stations whose input means are limited.

The video browsing interface of the present invention can be used not only for the video browsing but also for editing video contents.

Furthermore, the method, interface, and apparatus for video browsing of the present invention is applicable to an any independent apparatus and to a client apparatus in a client-server environment.

The foregoing embodiments and advantages are merely exemplary and are not to be construed as limiting the present invention. The present teaching can be readily applied to other type of apparatus. The description of the invention is intended to be illustrative, and not to limit the scope of the claims. Many alternatives, modifications, and variations will be apparent to those skilled in the art.

What is claimed is:

1. A video browsing method for simultaneously displaying a scene key frame list comprised of key frames representing each scene, and a scene structure key frame list comprised of important key frames representing an internal structure of each scene on the scene key frame list.

2. The method according to claim 1, wherein, if one key frame is selected from the scene key frame list, further displaying a moving picture viewer for reproducing a moving picture section corresponding to the selected key frame, wherein the moving picture viewer reproduces a media file from a start position of a section that the selected key frame represents

3. The method according to claim 1, further displaying a shot key frame list composed of key frames representing shots, which are included in the scenes selected from the scene key frame list.

4. The method according to claim 1, wherein the scene key frame list is sequentially arranged in time, and wherein the scene key frame list and the scene structure key frame list are displayed orthogonal to each other.

5. The method according to claim l, wherein each key frame on the scene key frame list is displayed according to index information, based upon start time of a media file.

6. The method according to claim 1, wherein a non-linear video browsing is conducted on the basis of scene unit by selecting a key frame on the scene key frame list.

7. The method according to claim 1, wherein, if shots are repeated in a scene, key frames included in the scene structure key frame list are key frames representing shots having a long running time in a unit of repetition among the repeated shots.

8. The method according to claim 1, further displaying a moving picture viewer for reproducing a moving picture section corresponding to each key frame of the scene key frame list or the scene structure key frame list, and displaying a shot key frame list composed of key frames that represent shots included in the scenes selected from the scene key frame list, wherein the moving picture viewer reproduces a media file from the start position of the section that the selected key frame represents.

9. An interface for video browsing, comprising:
a scene key frame list comprising key frames that represent each scene; and
a scene structure key frame list comprising important key frames that represent internal structures of each scene on the scene key frame list.

10. The interface according to claim 9, if one key frame is selected from the scene key frame list, further comprising a moving picture viewer, which reproduces a media file from a start position of a section represented by the selected key frame.

11. The interface according to claim 9, further comprising a shot key frame list composed of key frames representing shots included in the scene selected from the scene key frame list.

12. The interface according to claim 9, wherein the scene key frame list is arranged in time sequence, and wherein the scene key frame list and scene structure key frame list are displayed orthogonal to each other.

13. The interface according to claim 9, wherein each key frame on the scene key frame list is displayed according to index information based on a start time of a media file.

14. The interface according to claim 9, wherein a non-linear video browsing is conducted on the basis of a scene unit by selecting a key frame on the scene key frame list.

15. The interface according to claim 9, wherein, if shots are repeated in a scene, key frames included in the scene structure key frame list are key frames representing shots having a long running time in a unit of repetition among the repeated shots.

16. The interface according to claim 9, further comprising;
a moving picture viewer for reproducing a moving picture section corresponding to each key frame of the scene key frame list or the scene structure key frame list; and
a shot key frame list composed of key frames representing shots included in the scenes selected from the scene key frame list;
wherein the moving picture viewer reproduces a media file from a start position of representative section of the selected key frame.

17. An apparatus for video browsing, comprising:
a video browsing interface for simultaneously displaying a scene key frame list composed of key frames representing each scene and a scene structure key frame list composed of important key frames of each scene on the scene key frame list;
a control means for controlling reproduction of a media file according to index information, and for controlling, at a user's request, non-linear video browsing based on the scene key frame list and the scene structure key frame list;
an input means for receiving the user's request;
a media file storing means for providing a media file for video browsing; and
an index storing means for storing index information that includes structural information about scenes or shots, relevant key frame structure information connected thereto and time information.

18. The apparatus according to claim 17, wherein, if a key frame is selected from the scene key frame list, the video browsing interface further comprises a moving picture viewer for reproducing a moving picture section corresponding to a selected key frame from the start position of corresponding moving picture section.

19. The apparatus according to claim 17, wherein the video browsing interface further comprises a shot key frame list that is composed of key frames representing shots, which are included in the scene selected from the scene key frame list.

20. The apparatus according to claim 17, wherein if the video browsing is conducted in a client-server environment, the media file storing means and the index storing means are implemented on the server and the server provides the client apparatus with a corresponding media file based on the index information through communication network.
